(19) United States
(12) Patent Application Publication
(10) Pub. No.: US 2013/0014427 A1
(43) Pub. Date: Jan. 17, 2013

(54) Fishing Tackle Knot Funnel Body

(71) Applicant: Russell Robert Rothan, Chicago, IL (US)

(72) Inventor: Russell Robert Rothan, Chicago, IL (US)

(73) Assignee: CONSTELLATION LLC., Redmond, OR (US)

(21) Appl. No.: 13/548,605

(22) Filed: Jul. 13, 2012

Related U.S. Application Data
(60) Provisional application No. 61/508,194, filed on Jul. 15, 2011.

(51) Int. Cl. A01K 91/04; A01K 91/047

(52) U.S. Cl. 43/43.1

(57) ABSTRACT

An connection apparatus for fishing tackle that is adapted to allow the securement of the apparatus to a fishing line by the half-hitch, overhand knot or any other low dexterity knot through the use of at least one dual conical bores passing through the body of the apparatus. The apparatus generally incorporates another fishing tackle article such as a hook or split ring but can also be utilized alone when made of a suitable floating material. The configuration of the dual conical bores in relation to each other and in relation to the linear axis of the apparatus, lends itself to different purposes and different methods of securing different fishing tackle articles to the connection apparatus. With the use of a simple linear connector, two connection apparatuses may be adjoined to allow fishing lines of different sizes to be connected.

### RELATED APPLICATIONS

This patent incorporates by reference the entirety of, and claims priority under the benefit under Title 35, United States Code, §119(e) of the U.S. provisional patent application Ser. No. 61/508,194 filed on Jul. 15, 2011 and entitled “Fishing Tackle Knot Funnel.”

### FIELD OF THE INVENTION

The present invention relates generally to a new and novel device for simply securing and releasing a fishing line that has applications for all users, however is targeted for those users with reduced dexterity in their fingers as is common with older fishermen, arthritic fishermen or fishermen in cold climates.

### BACKGROUND OF THE INVENTION

The present invention relates to an extremely compact fishing tackle device that will simply allow for the connection of at least one fishing line in a quick-to-fasten and quick-to-release fashion that is adapted to provide both speed and convenience for the user. More particularly, to a fishing tackle device allowing a secure connection to at least one fishing line through the use of a simple knot whether it be a half-hitch, an overhand knot or another low dexterity, non complex knot. This device is secure enough connect the most expensive of lures without fear of loss, but for a broken fishing line.

The American populace is aging but living longer. Along with this comes avid sportsmen fishing well into their golden years. Many of those older fishermen no longer have the dexterity in their fingers to tie the minute and complicated knots that fishing tackle requires such as Albright knots, Eye Crosser Knots, Surgeons End Loops and the like. Anyone that has ice fished for any length of time can also attest to the lack of digit dexterity in the colder climates. As is with many of the very young fishermen that are blessed with small hands and ample dexterity, learning to tie fishing knots is often an arduous process. With all of the aforementioned examples, there are often problems encountered when trying to secure fishing line to an article of fishing tackle. All this said, the difficulty of tying the knot is only half of the problem. Once the knot is tied, releasing it is often an extended process.

Henceforth, a simple, quick and secure device to tie and untie at least one fishing line from an article of fishing tackle would fulfill a long felt need in the fishing industry. This new invention utilizes and combines known and new technologies in a unique and novel configuration to overcome the aforementioned problems and accomplish this.

### SUMMARY OF THE INVENTION

The present invention relates to a fishing tackle body with a knot funnel formed therein. More specifically, an apparatus or specially designed body to allow secure connection between many kinds of fishing tackle and lines with a simple knot. The general purpose of the present invention, which will be described subsequently in greater detail, is to provide a fishing tackle body that is capable of quick, simple and secure affixation to at least one fishing line. It has many of the advantages mentioned heretofore and many novel features that result in a new fishing tackle body which is not anticipated, rendered obvious, suggested, or even implied by any of the prior art, either alone or in any combination thereof.

In accordance with the invention, an object of the present invention is to provide an improved article of fishing tackle capable of simple connection to at least one fishing line.

It is another object of this invention to provide an improved article of fishing tackle capable of securely connecting two fishing lines regardless of any disparities in the sizes of the two lines.

It is a further object of this invention to provide an improved article of fishing tackle capable of allowing connection of at least one fishing line to a hook, bobber, lure or line connector.

It is still a further object of this invention to prevent the loss of fish from poorly tied knots.

It is a further object of the present invention to provide a device that is easy to thread than a standard hook, lure, weight, floater, or other kind of fishing equipment such that it allows a user to change lures and tackle ten times faster than with standard lures and tackle.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a perspective view of the cross section of the fishing tackle knot funnel body affixed to a standard fishing hook and monofilament fishing line showing the general arrangement of all components;

FIG. 2 is a perspective view of the fishing tackle knot funnel body affixed to a standard fishing hook;

FIG. 3 is a perspective cross section a view of the first alternate embodiment of the fishing tackle knot funnel body with an imbedded split ring lure connector;

FIG. 4 is a cross sectional front view of the first alternate embodiment of the fishing tackle knot funnel body with an imbedded split ring connector;

FIG. 5 is a perspective view of the first alternate embodiment of the fishing tackle knot funnel body with an imbedded split ring connector that is connected to a fishing lure;

FIG. 6 is a front cross sectional view of the second alternate embodiment fishing tackle knot funnel body in its simplest longitudinal funnel configuration without connection means to any fishing tackle;

FIG. 7 is a front cross sectional view of the second alternate embodiment fishing tackle knot funnel body in its longitudinal offset funnel configuration without connection means to any fishing tackle;

FIG. 8 is a front cross sectional view of the second alternate embodiment fishing tackle knot funnel body in its obtuse angled funnel configuration without connection means to any fishing tackle;

FIG. 9 is a front cross sectional view of the second alternate embodiment fishing tackle knot funnel body in its axial funnel configuration without any connection means to any fishing tackle;

FIG. 10 is a front cross sectional view of the second alternate embodiment fishing tackle knot funnel body with its dual funnel line connector configuration;

FIG. 11 is a perspective view of the third alternate embodiment of two different sized fishing tackle knot funnel bodies releasably, mechanically coupled in a linear connector;

FIG. 12 is a front cross sectional view of the third alternate embodiment of two different sized fishing tackle knot funnel bodies mechanically coupled in a linear connector;

FIG. 13 is a front cross sectional view of the second embodiment fishing tackle knot funnel body as used in a bobber configuration;

FIG. 14 is a cross section of the fourth alternate embodiment fishing tackle knot funnel body, and

FIG. 15 is a cross section of the fifth alternate embodiment fishing tackle knot funnel body.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

The present invention is a fishing knot tackle body 2 with a knot funnel formed therethrough that accommodates fishing line 6 securely to the tackle body 2 with but the tying of a simple knot 11. The tackle body 2 may be directly coupled to some other tackle, to a tackle connector or to another substantially similar tackle body 2. FIG. 6 is a cross sectional view of a fishing tackle knot funnel body 2 with a fishing line 6 threaded therethrough. It can be seen that the knot funnel is two mirror image right circular conical bores cut into the solid body 18 such that they share a common linear axis and their apexes (if extended to continue beyond the point of the bore's intersection) would lie within the volume created by each of the other's respective bore, their geometrical bases lying on the outer surface of the solid body 18, so as to generally form an hourglass configuration therein the solid body 18, and the narrowest area of the bore (the neck 9) residing generally in the center of the solid body 18. Optionally, there may be chamfered edges where their bases (funnel first end 8 and funnel second end 10) are cut into the solid body (to prevent fraying of the fishing line.) Their common linear axis passes through the center of the bases of their respective conical bores. (This is a modified version of a doubly infinite cone.) In non mathematical terminology, the fishing tackle knot funnel body is a solid body having at least one, dual tapered funnel bore formed through it having a generally hourglass profile with a first opening on the solid body's exterior surface (funnel first end 8) having a first diameter and a substantially similar second opening on the solid body's exterior surface (funnel second end 10) having a second diameter (generally identical to the first diameter) where the

dual tapered bore tapers inward from each of the openings to a neck residing centrally in bore and having the smallest diameter of said bore.

The interior angle of the cone determines how deep into the conical bore the knot 16 will reside. The neck 9 has a diameter limited to ranges of sizes in order to work. It must be large enough to accommodate the thickness of one single strand of the fishing line 6 but yet too small to accommodate a double thickness of the same strand of fishing line 6 so that the line, when knotted once, will not pass back through the neck 9. Larger diameter necks will of course accommodate all sizes of fishing lines that are able to be passed in their single strand form through the neck 9, but will require the use of multiple knots 16 to keep the fishing line 6 from being pulled back through the neck 9. This would take away from the purpose and general design of the invention, hence the reason for different sized bores to accommodate only specified diameter ranges of fishing lines.

The optimal design for use with a single simple knot thus requires the diameter of the neck must be greater than the diameter (thickness) of the fishing line 6 that the fishing tackle knot funnel body 2 is to be connected to but less than twice the diameter of the same fishing line 6. The first and second openings of the funnel bore 8 and 10 must be more than twice the diameter of the same fishing line. This will accommodate the passing of a non knotted fishing line through the entire funnel bore, the partial retraction of the same, now knotted fishing line from the funnel bore so as to pass down one of the funnel bore openings, causing the knot to decrease in size to approximately twice the diameter of the fishing line, but not allowing it to pass through the neck 9.

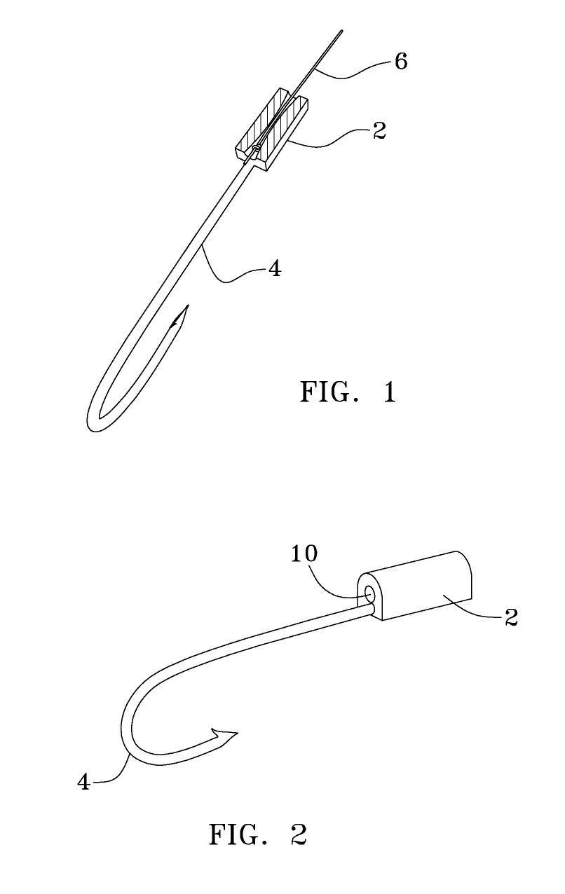

Looking at FIGS. 1 and 2, views of the fishing tackle knot funnel body 2 affixed to a standard fishing hook 4 and monofilament fishing line 6 can be seen. The fishing line 6 remains constrained from passing through the narrowest section (the neck) of the funnel because of the size of the knot tied adjacent the end of the fishing line. The fishing hook 4 may be affixed to the fishing tackle knot funnel body 2 by a plethora of mechanical methods. It may be soldered or welded on, molded into, glued into a recess formed in the fishing tackle knot funnel body 2, or even cast as one piece. Direct connection of the fishing tackle knot funnel body 2 to another article of tackle is preferred with hooks and some lure designs, while connection to other tackle is better suited through the use of leaders and/or split rings affixed to the fishing tackle knot funnel body 2. FIG. 2 shows the funnel second end 10 from a bottom perspective with the fishing line 6 removed.

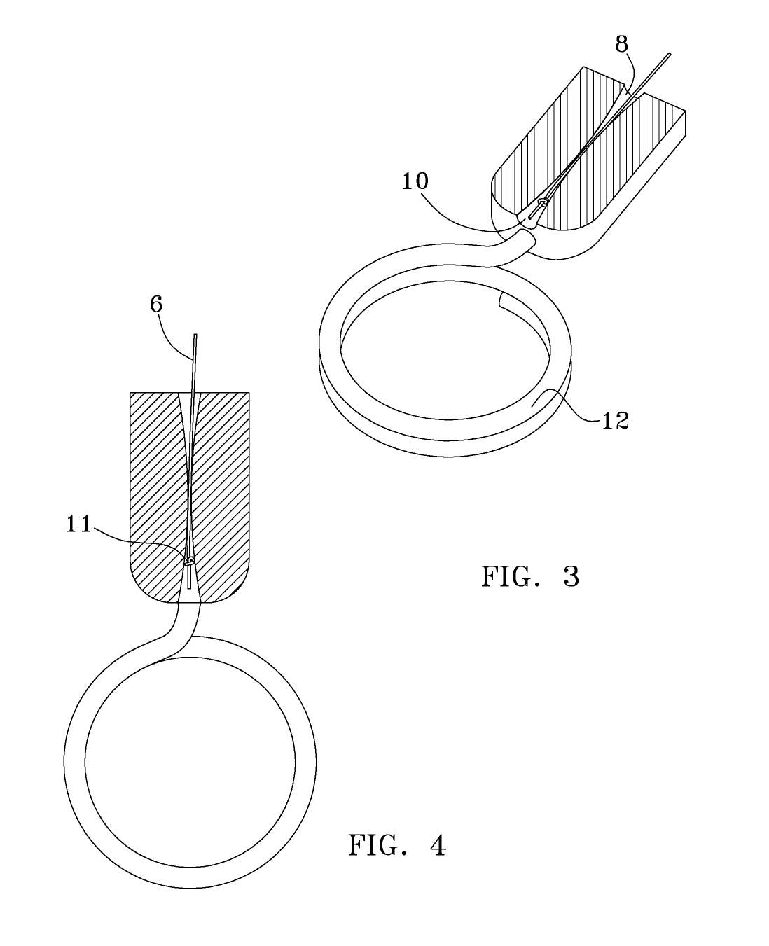

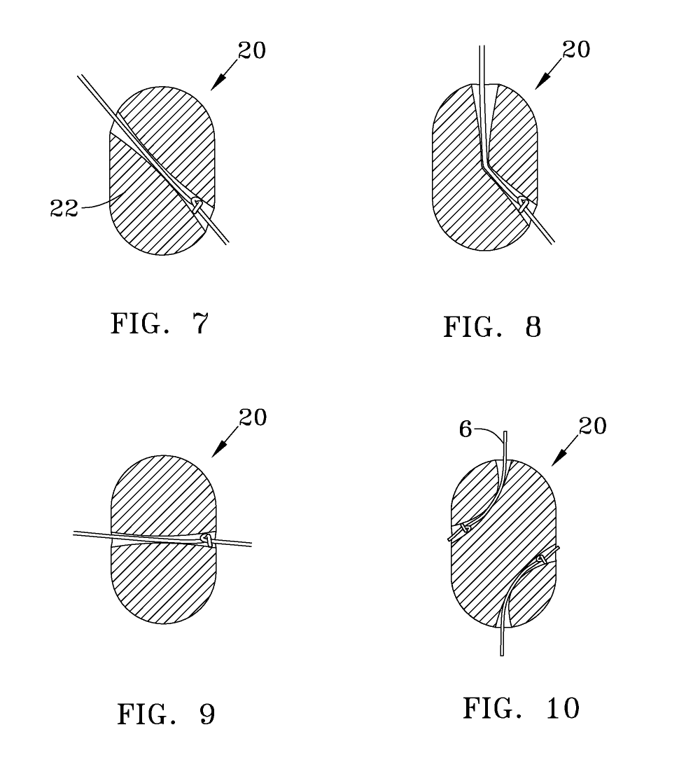

FIGS. 3 and 4 illustrate the fishing tackle knot funnel body 2 affixed to a split ring 12 for the attachment of another article of fishing tackle such as a lure. The split ring is affixed to the solid body of the fishing tackle knot funnel body 2 adjacent the funnel second end 10. The actual geometric shape of the fishing tackle knot funnel body 2 is not fixed but is dictated mostly by the function of that fishing tackle knot funnel body 2. Where there is an imbedded part of an article of fishing tackle, such as the split ring 12, the size or volume of the solid body of the fishing tackle knot funnel body 2 may the thickened. This will prevent tear out of the imbedded part of an article of fishing tackle, as could be expected when fighting a fish. The material used for the construction of the fishing tackle knot funnel body 2 dictates the dimensions of its solid body. Where steel is used, a smaller overall dimension is adequate, such as in the fishing hook configuration of FIGS. 1 and 2. Where a polymer is used with an imbedded steel article of fishing tackle, such as the split ring of the present figures, a larger dimension is necessary. The exterior configuration of the fishing tackle knot funnel body 2 will generally be cylindrical (round or polygonal) although the ends may be planar, tapered, chamfered or rounded. The most common physical configuration will be that of the fishing tackle knot funnel body 2 shown in FIGS. 7 to 10.

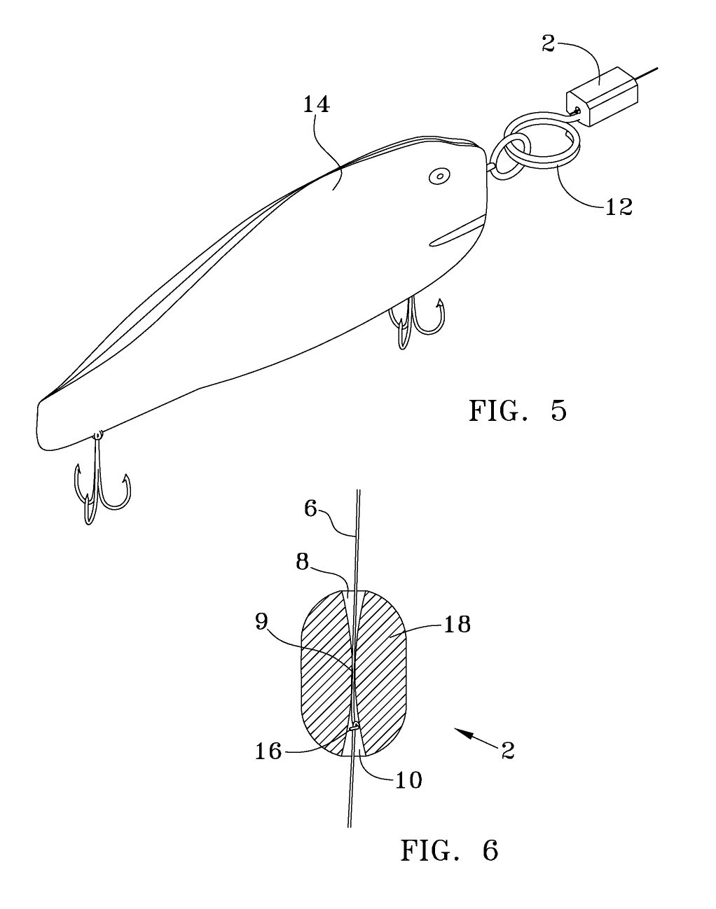

FIG. 5 shows a fishing tackle knot funnel body 2 connected to a split ring as in FIGS. 3 and 4 but with a different physical configuration, that of an irregular octagonal cylinder. It also shows the connection between a fishing lure 14 and the split ring 12. In lieu of a split ring a direct connection to a fishing lure may be made in a similar fashion by the use of a simple connector that is imbedded in both the lure and the fishing tackle knot funnel body 2 as would be well known in the industry.

In operation, the fishing line 6 is threaded down the base of the funnel first end 8, through the funnel neck 9 and out of the base of the funnel second end 10, tied in a simple knot, and then partially pulled back out the funnel first end 8 such that the simple knot compresses/tightens in on itself as it traverses along the tapered walls of the funnel bore, stopping by abutment with the tapered side walls in the area adjacent the neck 9 of the funnel bore. The taper of the funnel bore is used to compress or tighten a simple knot in the fishing line such as a half-hitch, a slip knot, a stopper knot or an overhand knot (to name a few) by pulling on the fishing line from the funnel first end 8 that the fishing line was originally fed through. This manner of use renders the knot so compacted that there is too much resistance between the sections of the fishing line that form the knot and touch each other to possibly allow the knot to come undone. The size of this compressed knot however, is too large to pass back through the funnel neck. To remove the fishing line, the knot is pushed away from the funnel neck past the funnel second end 10 where the fishing line is cut just above the knot. The fishing line is then pulled through the neck and out past the funnel first end 8, freeing the fishing line from the tackle body. Since the fishing tackle knot funnel body 2 only works with a limited range of diameters of fishing lines when only one simple knot is used, different sized fishing tackle knot funnel bodies 2 may be color coded where each color represents an acceptable range for the diameters of fishing line that can be used.

FIGS. 7 to 10 show the second alternate embodiment fishing tackle knot funnel body 20 with different configurations of the funnel bore that are oriented differently through the solid body. These are to accommodate different purposes and different methods of connection to other fishing tackle devices. All four of these FIGS represent linear knot funnels that do not share their longitudinal axis with the longitudinal axis of the solid body. When this occurs more of the solid body is available for the imbedding of fishing tackle attachment devices into the end areas 22 of the solid body, such as split rings, leaders and the such. It may also allow the fishing tackle knot funnel body 2 to have a different physical orientation with respect to the fishing line and the tackle apparatus to be connected. The second alternate embodiment fishing tackle knot funnel body of FIG. 10 allows for the coupling of two fishing lines simultaneously while retaining the second alternate embodiment fishing tackle knot funnel body's longitudinal axis aligned with the fishing line. If the funnel bores have different necks 9 and corresponding sized funnel ends, then different sized fishing lines 6 can be joined.

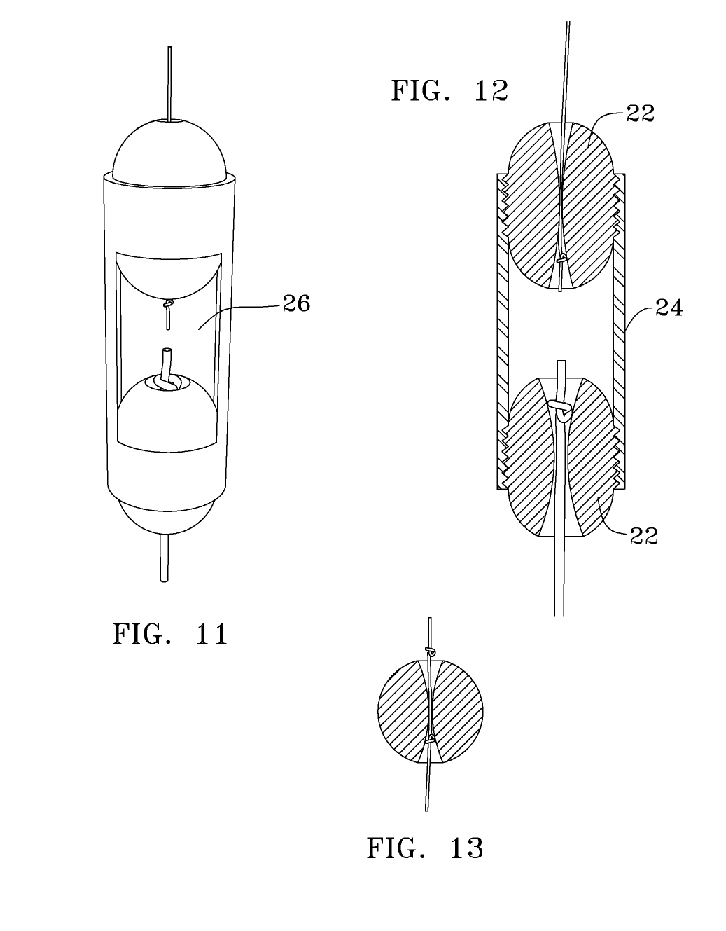

Looking at FIGS. 11 and 12 a third alternate embodiment of the fishing tackle knot funnel body can best be seen. Here, two similar, connectable fishing tackle knot funnel bodies 22 are connected by threaded engagement with a connection coupling 24 such that they all share a common, central, longitudinal axis. The connection coupling 24 is a hollow cylinder with at least section of its sidewall removed to form a window 26. The ends of the connection coupling are internally threaded to matingly engage threads formed on the exterior surface of the third embodiment fishing tackle knot funnel body 22. This connection coupling 24 allows for third alternate embodiment fishing tackle knot funnel bodies 22 having different neck diameters to be coupled together. This connection coupling 24 accommodates tying together two lines of different sizes. This is a commonly utilized procedure when connecting a leader of a generally heavier and more durable test line, to a lighter test line.

In operation, the fishing lines are attached to each of the third alternate embodiment fishing tackle knot funnel bodies 22 in the same fashion as described above. The third alternate embodiment fishing tackle knot funnel bodies 22 are now each threaded into the connection coupling 24 and simultaneously tightened. Because of the location of the window 26 it is not necessary to ever remove the third alternate embodiment fishing tackle knot funnel bodies 22 from the connection coupling 24. The fishing line can be removed from either of them by pushing the fishing line down through the funnel bore until it extends far enough into the body of the connection coupling 24 to be extracted through the window 26 and cut above the knot. Additionally, because of the window 26 it is possible to also connect new fishing line to either of the third alternate embodiment fishing tackle knot funnel bodies 22. Although illustrated with one window 26 it is known that there may be more than one window 26 cut into the sidewall.

FIG. 13 shows a second alternate embodiment fishing tackle knot funnel body that is also used as a float or bobber. In this configuration the solid body is of a non porous material with a density less than water and a knot is tied both below and above the neck 9 in the funnel bore.

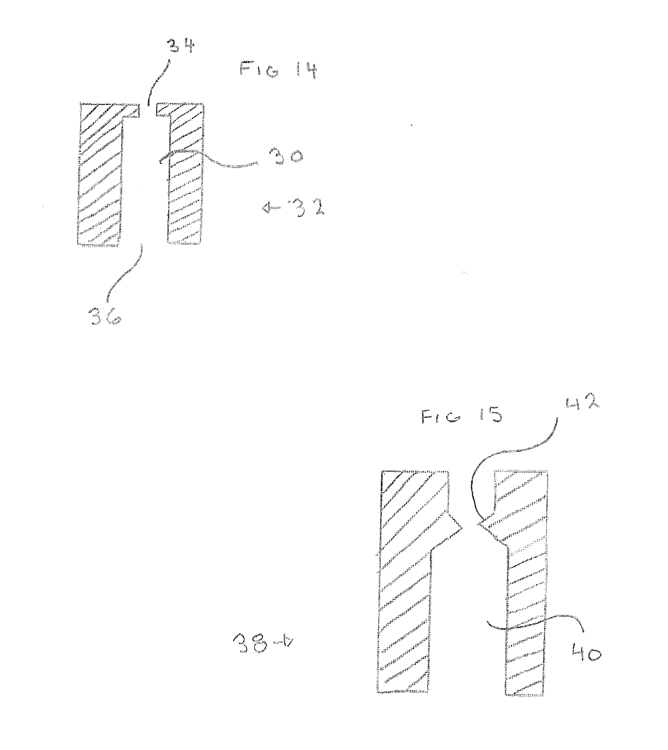

Looking at FIGS. 14 fourth and fifth embodiments of the present invention can best be seen. This is a simplified version that lends itself to easier fabrication although it does not have the aesthetic appeal of the earlier presented embodiments. Each operates to secure a simply knotted fishing line in the same manner as all of the embodiments described above. The relationship of the dimensions of the various openings and necked down regions are critical. It is known that the knot of a simply knotted line, regardless of the amount of compression or tightening, never decreases in size to twice the diameter of the unknotted region of the same fishing line.

In FIG. 14 shows the simplest design wherein the bore 30 of embodiment four 32 ha no necked down region as does a funnel bore, rather has but a stepped diameter design. The entrance opening 34 has a diameter large enough to accommodate an unknotted fishing line yet smaller than twice the diameter of the same unknotted fishing line while the exit opening 36 has a diameter greater than twice the diameter of the same unknotted fishing line. Since the knotted region of a fishing line exceeds twice the diameter of an unknotted fishing line, once the unknotted fishing line is fed through the entire bore 30 and knotted, it cannot be passed out of the bore 30 through the entrance opening 34.

Looking at the fifth embodiment 38 (FIG. 15), it can be seen that this embodiment merely shifts the knot restraining region 42 down the length of the modified bore 40 between the openings. It functions in the same manner to restrain the fishing line. It is to be noted that in this modified bore design, as is with the funnel knot bore design, the openings on the exterior surfaces of the solid body may be of the same size or they may be of different sizes. However, if they are to be of the same size they would have to be more than twice the size of the unknotted fishing line it is to be utilized with.

Attaching a fishing hook, lure or split ring to either of the fourth or fifth embodiments would be as described earlier and given the disclosure herein would be well within the ability of one skilled in the art. Similarly, external threads can be incorporated onto the exterior of these embodiments so that they would threadingly engage the internal threads of the connection coupling 24 and work in the same fashion as described above.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

What is claimed is:

1. A fishing line coupling apparatus of fishing tackle comprising:
at least one solid body having at least one dual tapered funnel bore formed therethrough, said bore having an hourglass profile with a first opening of a first diameter located on an exterior surface of said solid body and a substantially similar second opening of a second diameter located on an exterior surface of said solid body;
wherein said bore tapers inward from each of said openings to a neck of a third diameter residing centrally within said bore, said third diameter being the smallest diameter of said bore and being less than one half the size of said first diameter.

2. The fishing line coupling apparatus of claim 1 further comprising a fishing hook, wherein said coupling apparatus is affixed to a straight end of a fishing hook.

3. The fishing line coupling apparatus of claim 1 further comprising a fishing line wherein said fishing line has a fourth diameter that is at least greater than one half the size of said third diameter of said neck of said fishing line coupling apparatus.

4. The fishing line coupling apparatus of claim 3 wherein said funnel bore has a longitudinal axis that is linear.

5. The fishing line coupling apparatus of claim 3 wherein said funnel bore has a longitudinal axis that is non-linear.

6. The fishing line coupling apparatus of claim 3 wherein said funnel bore axis is common with a longitudinal axis of said solid body.

7. The fishing line coupling apparatus of claim 3 wherein said funnel bore axis is not common with a longitudinal axis of said solid body.

8. The fishing line coupling apparatus of claim 1 wherein the number of funnel bores is two.

9. The fishing line coupling apparatus of claim 1 further comprising a split ring affixed to said coupling apparatus.

10. The fishing line coupling apparatus of claim 9 wherein said split ring is a coiled wire with a linear section extending normally therefrom and adapted for connection with said fishing line coupling apparatus by frictional engagement therein.

11. The fishing line coupling apparatus of claim 1 further comprising a fishing lure directly affixed to said coupling apparatus.

12. The fishing line coupling apparatus of claim 1 further comprising a connector coupling and where the number of solid bodies is two.

13. The fishing line coupling apparatus of claim 12 wherein said solid bodies have an exterior thread formed thereon that matingly conforms to either of two substantially similar threads formed on an internal surface of a distil end and the internal surface of a proximate end of said connector coupling.

14. The fishing line coupling apparatus of claim 13 wherein said connector coupling is a hollow cylinder with at least one cut out region centrally located in said cylinder.

15. A fishing line coupling apparatus of fishing tackle for coupling a fishing line of a first diameter comprising:
at least one solid body having at least one bore formed therethrough, said bore having an entrance opening having a second diameter located on an exterior surface of said solid body and an exit opening having a third diameter located on an exterior surface of said solid body;
wherein said second diameter is dimensionally larger than said first diameter by no more than 100%, and said third diameter is dimensionally larger than said first diameter by more than 100%.

16. The fishing line coupling apparatus of claim 15 further comprising a fishing hook, wherein said coupling apparatus is affixed to a straight end of a fishing hook.

17. The fishing line coupling apparatus of claim 15 further comprising a split ring affixed to said coupling apparatus.

18. A fishing line coupling apparatus of fishing tackle for coupling a fishing line of a first diameter comprising:
at least one solid body having at least one bore formed therethrough, said bore having a length, an entrance opening having a second diameter located on an exterior surface of said solid body, an exit opening having a third diameter located on an exterior surface of said solid body and a necked down region that is disposed along said length of said bore and has a fourth diameter;
wherein said second diameter is dimensionally larger than said first diameter and said third diameter is dimensionally larger than said first diameter by more than 100%, and said fourth diameter is dimensionally larger than said first diameter by no more than 100%.

19. The fishing line coupling apparatus of claim 18 further comprising a fishing hook, wherein said coupling apparatus is affixed to a straight end of a fishing hook.

20. The fishing line coupling apparatus of claim 19 further comprising a split ring affixed to said coupling apparatus.
